(19) United States
(12) Patent Application Publication
(10) Pub. No.: US 2003/0035704 A1
(43) Pub. Date: Feb. 20, 2003

(54) Universal access chamber and method for the insertion of treatment devices and materials into an in-service pipeline

(76) Inventor: Lembit Maimets, Richmond Hill (CA)

Correspondence Address: GREENBLUM & BERNSTEIN, P.L.C., 1941 ROLAND CLARKE PLACE, RESTON, VA, 20191, US

(21) Appl. No.: 10/217,407

(22) Filed: Aug. 14, 2002

Related U.S. Application Data
(60) Provisional application No. 60/312,072, filed on Aug. 15, 2001.
(60) Provisional application No. 60/322,463, filed on Sep. 17, 2001.

(51) Int. Cl. B65G 1/00

(52) U.S. Cl. 414/217

(57) ABSTRACT

An apparatus for the insertion of treatment devices and materials into an in-service main pipe, which includes four main features. These features include the following: a casing hermetically mounted on the main pipe; a structure to seal access and exit compartments of the casing from the inside; access and exit containers hermetically attached to the casing; and a structure to transfer treatment devices and materials into and within the main pipe. The access container is provided with the magazine for the supply of boxes with repair sleeves. Provided with the main pipe is a smooth covering for casing sealing ability.

### CROSS-REFERENCE TO RELATED APPLICATION

This application is based upon U.S. patent application Ser. No. 60/312,072, filed Aug. 15, 2001, and U.S. patent application Ser. No. 60/322,463, filed Sep. 17, 2001, the disclosures of which are hereby incorporated-by-reference thereto in their entireties, and the priorities of which are hereby claimed under 35 U.S.C. §119.

### BACKGROUND OF THE INVENTION

1. Field of the Invention

This invention relates to an apparatus and method for use in the treatment of a pressurized system, more specifically, for inserting treatment devices and materials into a pipeline without interrupting the fluid flow.

2. Description of Background and Relevant Information

The equipment used for inspection and repair of an in-service pipeline are self-propelled automated devices, as a rule. See, for example, U.S. Pat. No. 6,104,772.

To insert such equipment without interrupting the fluid flow through the pipeline, it is necessary to mount the hermetical casing, such as a chamber, a branch line, or a simple saddle clamp, on the main pipe followed by cutting an opening between the casing and the main pipe. See, for example, U.S. Pat. Nos. 524,006; 555,079; 5,065,780; and 5,660,202. These patents represent a universally known principle of alternate (one at a time) opening of two gates for insertion/removing devices in order to prevent fluid from escaping through a pipeline cutout. An exception is the case of a single liquid seal, like a reservoir that is destined for systems under relatively low pressure. See, for example, U.S. Pat. No. 4,334,806.

U.S. Pat. No. 5,660,202 discloses an apparatus in the field of the present invention. The apparatus disclosed in this patent includes two gates, namely, one made as a movable device supported with sealing edges having long and intricate shapes, causing the unreliability in the service seal.

### SUMMARY OF THE INVENTION

It is a primary object of the present invention to provide an apparatus for use in the treatment of an in-service pipeline without interrupting fluid flow, which enables:

insertion of fully automated and remotely controlled devices, as well as devices requiring direct control by the operator;

permanent access into the in-service pipeline with a simple and reliable open/close position;

build up of additional chambers, pipes, and/or connections as required.

In accomplishing the above object, this invention includes an apparatus for the insertion of devices and materials into an operating service main pipe without interrupting the service. This includes the following: a casing hermetically mounted on the main pipe; a structure for sealing access and exit compartments of the casing from the inside; access and exit containers hermetically attached to the casing; and a structure for the transfer of treatment devices and materials into and within the main pipe.

Provided with the casing are sealing arrangements which hermetically enclose the devices and materials contained therein.

To allow the casing to be hermetically mounted, the main pipe provided with a smooth covering before the casing is installed.

In accordance with one embodiment of this invention, the casing provided with fittings in order to adjust the casing to main pipes with different diameters.

The casing access and exit compartments are correspondingly provided with access and exit containers for storage, transfer, and supply of equipment, materials, and cables for transport, manipulation, and communication into and within the main pipe.

The access container is provided with a magazine for supply of boxes with repair sleeves.

### BRIEF DESCRIPTION OF DRAWINGS

Other objects, features and advantages of the present invention will become apparent from the detailed description of the preferred embodiments of the invention, which follows, when considered in the light of the accompanying drawings of non-limiting examples of the present invention, in which:

FIG. 1 is a sectional view illustrating the apparatus for the insertion of treatment devices and materials into an in-service pipeline according to the present invention;

FIG. 2 is a cross-sectional view taken on the line A-A in FIG. 1;

FIG. 3 is a sectional view taken on the line B-B in FIG. 1;

FIG. 4 is a sectional view of the apparatus for the insertion of treatment devices and materials into an in-service pipeline which comprises the magazine for supply of boxes with repair sleeves;

FIGS. 4a-4c are sectional views of the box with the repair sleeve and an installation plug with bellows in accordance with one of the embodiments of this invention;

FIGS. 5a-5c arc sectional views of the apparatus for the insertion of treatment devices and materials into an in-service pipeline in the state for cutting out the segment from the in-service pipeline;

FIGS. 6a-6f schematically illustrate the order of the steps in the inspection of the main pipe in accordance with this invention;

FIGS. 7a-7h schematically illustrate the order of the steps in the repair of the main pipe in accordance with this invention;

FIGS. 8a-8d illustrate the order of the steps in the repair of the main pipe in accordance with other embodiments of this invention.

### DETAILED DESCRIPTION OF THE INVENTION

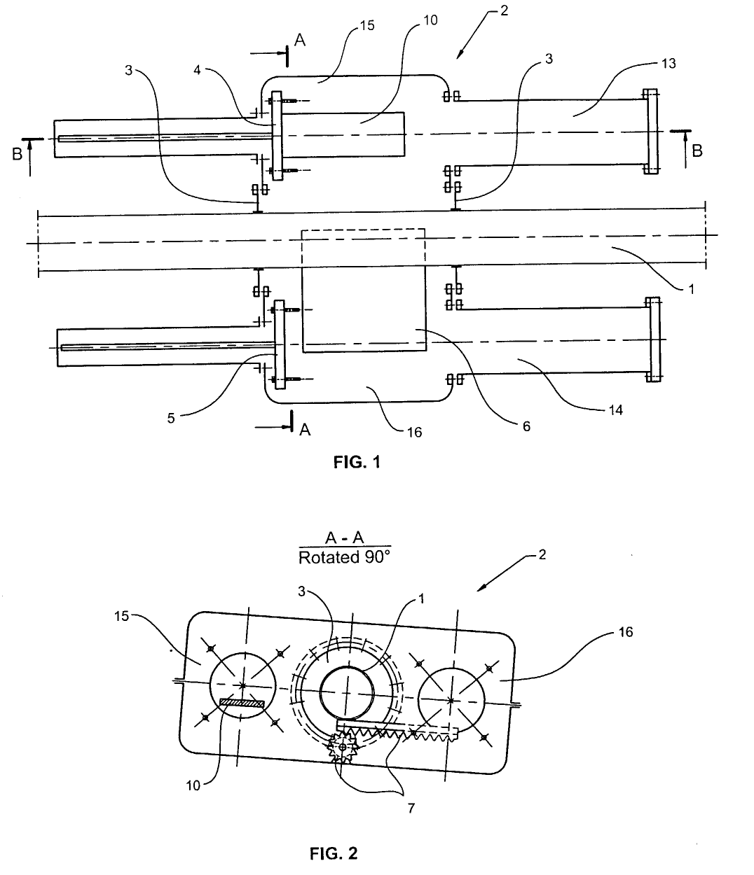

Shown in FIGS. 1 and 2 is one of the preferred embodiments in accordance with this invention. Apparatus for the insertion of treatment devices and materials into an in-service pipeline comprises a casing 2 hermetically mounted on the main pipe 1, access damper 4 and exit damper 5 for sealing casing 2 from inside, access 13 and exit 14 containers, which are hermetically attached to the casing 2, side tray 6 and access tray 10 for transferring treatment devices and materials into the main pipe 1.

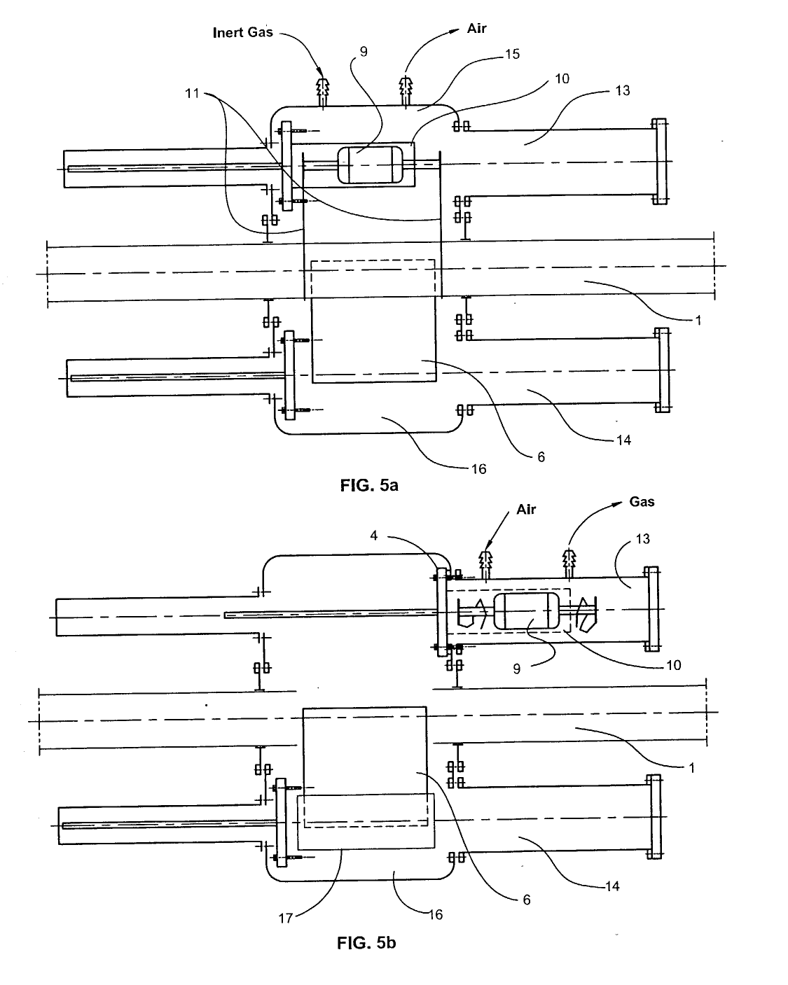

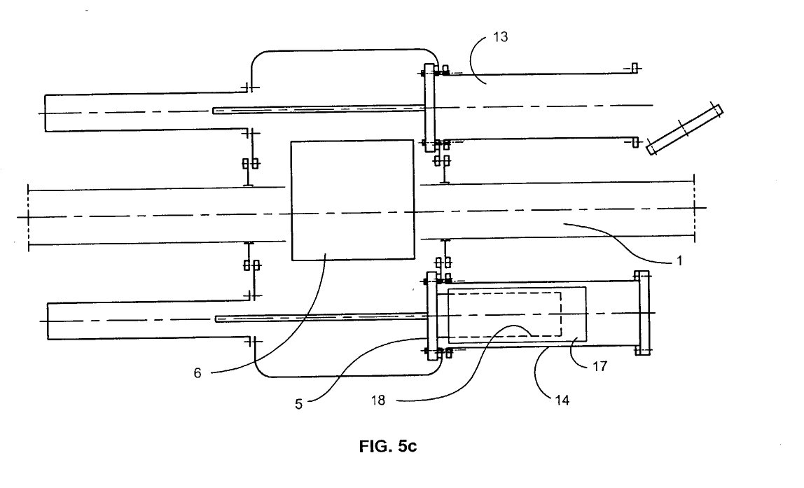

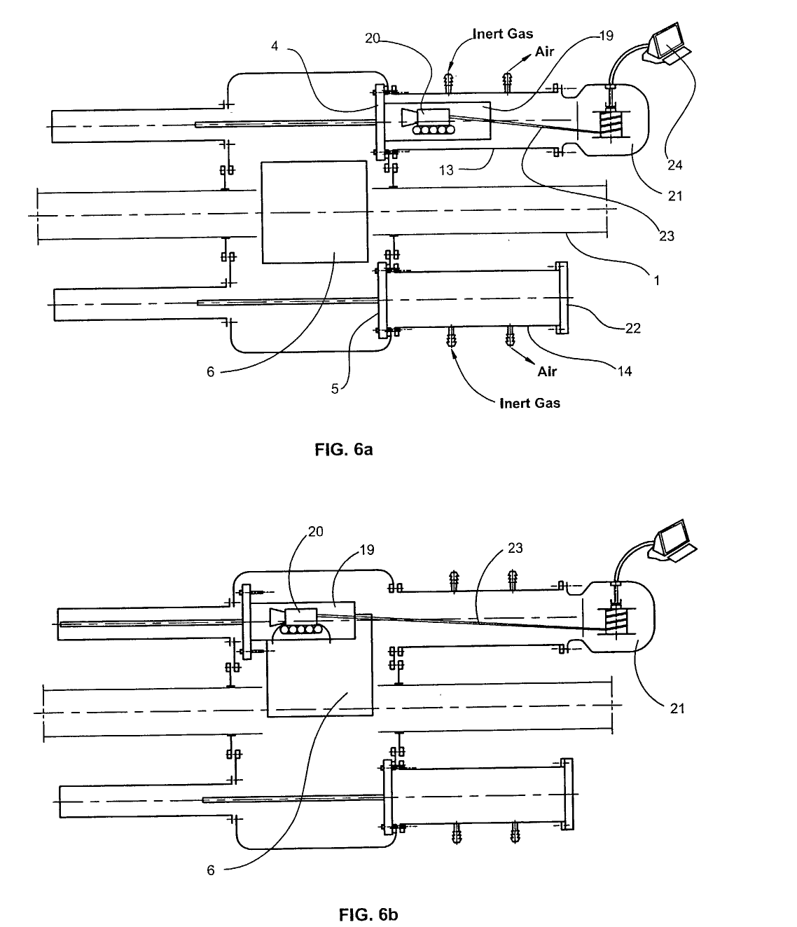

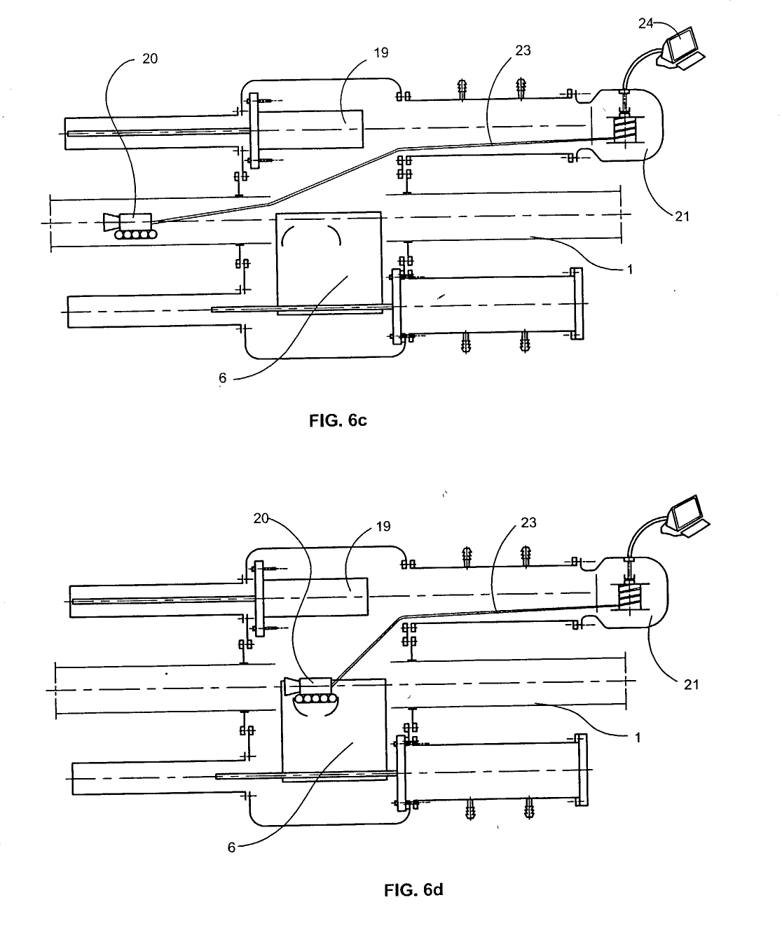

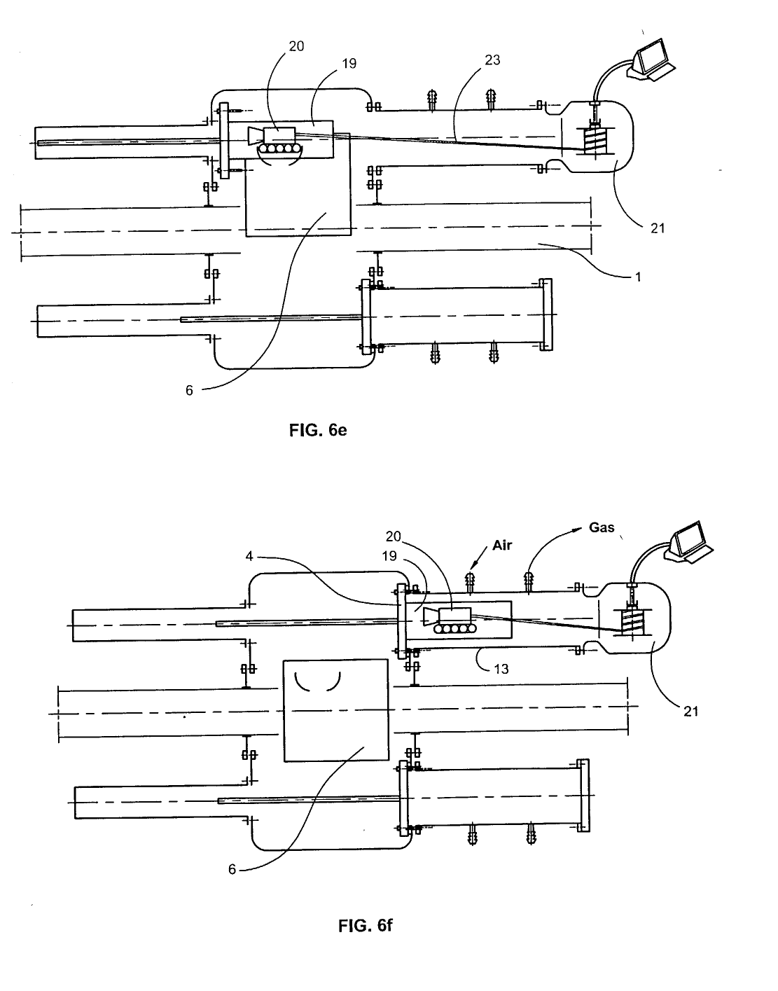

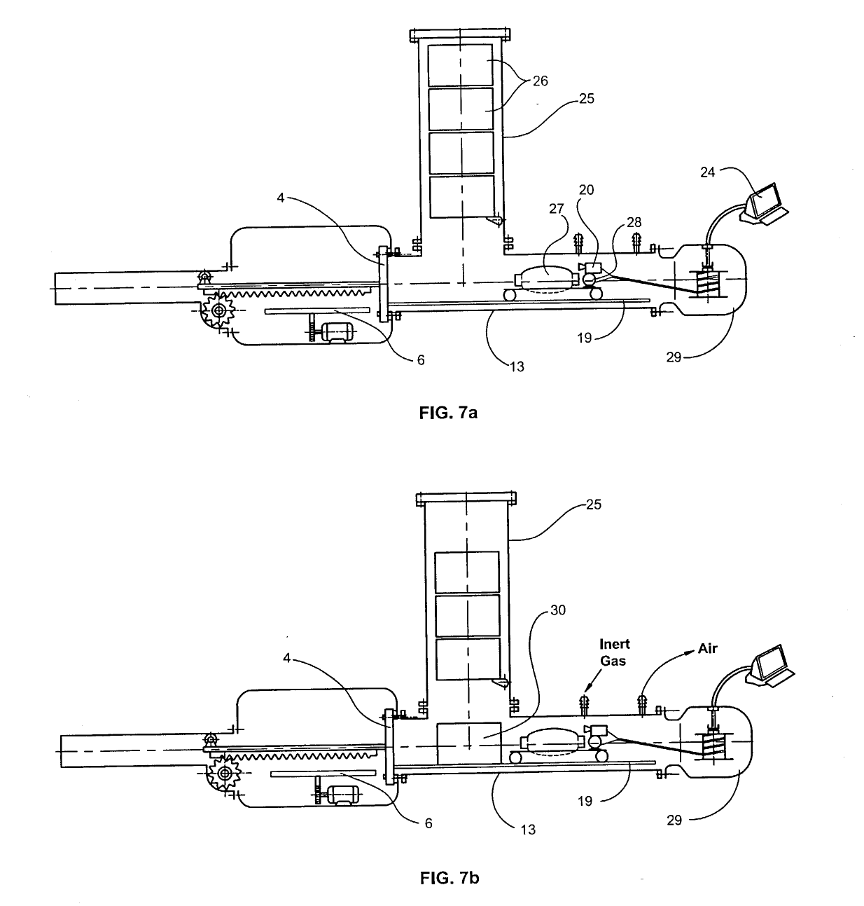

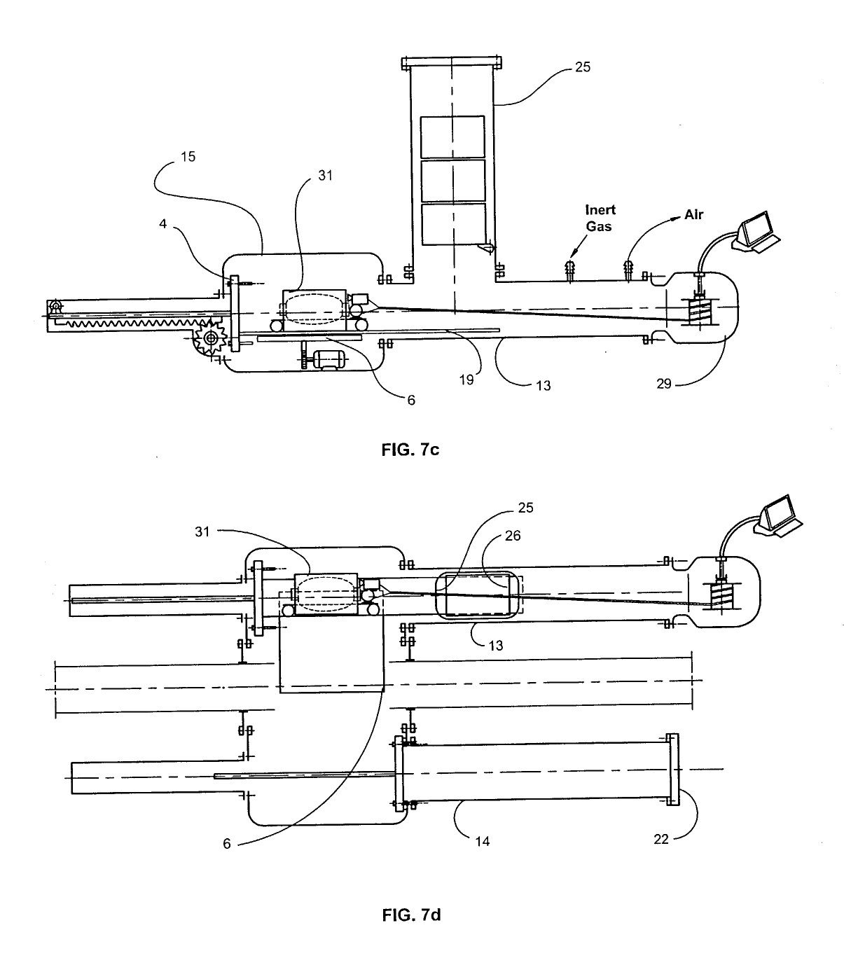

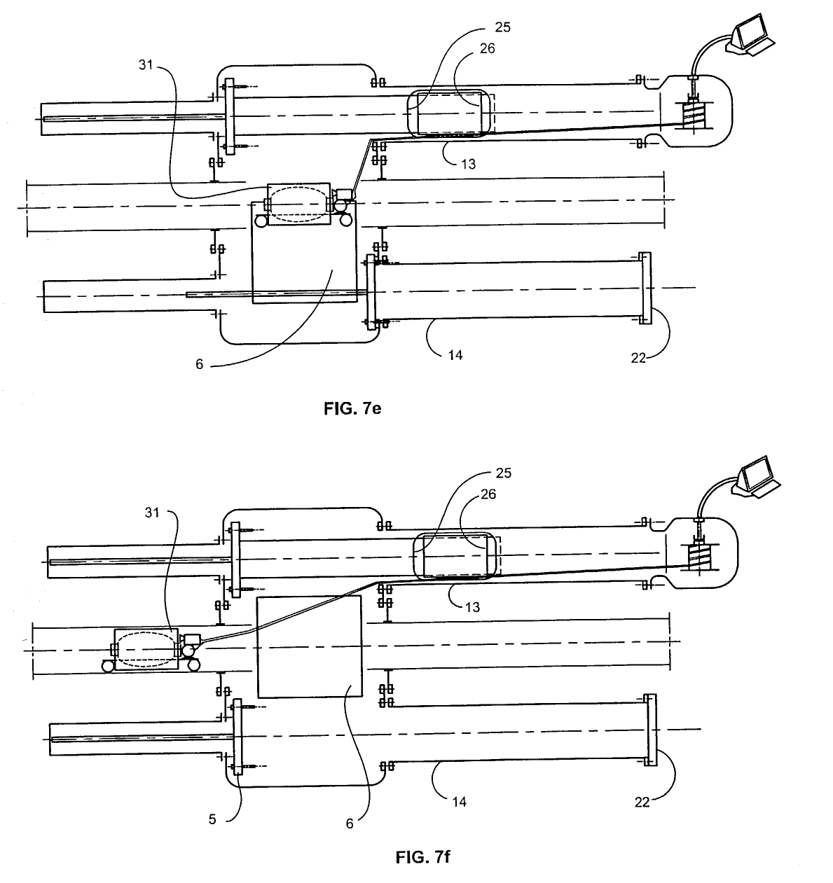

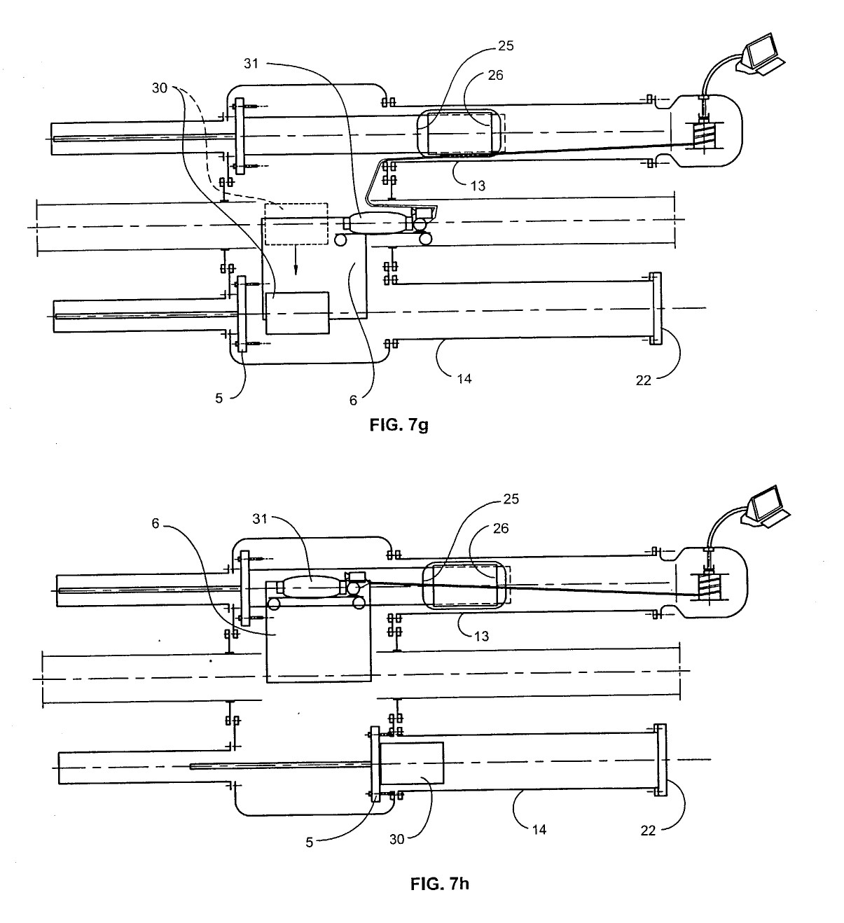

Further, casing 2 includes access compartment 15 and exit compartment 16. In accordance with this embodiment, the casing 2 is provided with fittings 3 in order to adjust the casing to main pipes with different diameters. Access damper 4 and exit damper 5 are each provided to have axial movements which can be provided, for example, by a rack and pinion mechanism 8. In turn, side tray 6 can be provided with a side movement mechanism 7. Access tray 10 is mounted on the access damper 4 and may be replaced with other trays with different shapes and dimensions, if required. For instance, such access tray may be a cutter platform (see FIG. 5a), or an access tray 19 for a CCTV camera (FIG. 6a), or an access tray 19 for a repair kit 31 (FIG. 7c). The similar exit tray 18 (see FIG. 5c) is mounted on the exit damper 5.

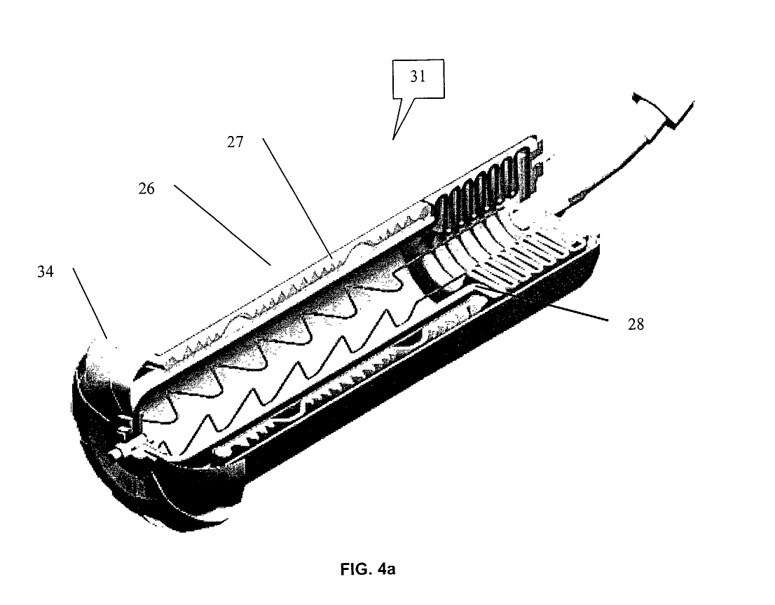

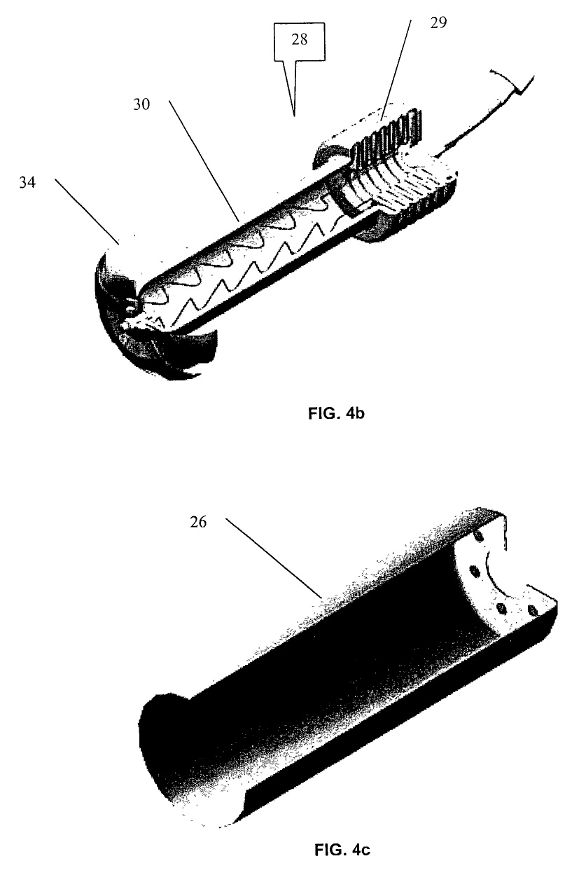

FIG. 4 shows another embodiment of this invention, where access container 13 is provided with a magazine 25 for the supply of boxes 26 with repair sleeves for use in internal repair of the pipe.

FIGS. 4a-4c show one of the embodiments of this invention with a repair sleeve 27 and an inflatable part 28, which permanently belongs to this particular box 26. FIG. 4b illustrates the part 28 separately with protective cone 34. Inflatable part 28 comprises bellows 29 and installation plug 30. FIG. 4c illustrates box 26 separately.

FIGS. 5a-5c show one of the embodiments of this invention for cutting out segment 17 from the in-service main pipe 1 by the use of cutter 9 with two diamond wires 11. Cutter 9 is mounted on cutter platform 10.

FIGS. 6a-6f illustrate inspection action within the in-service main pipe 1. Access tray 19 is mounted on the access damper 4, access container 13 is attached to access compartment 15 of casing 2, and CCTV drum 21 is attached to the access container 13. Remote control device 24 is connected to CCTV drum 21. CCTV crawler camera 20 is placed on access tray 19.

FIGS. 7a-7h illustrate a repair process within the in-service main pipe 1. Access tray 19 is mounted on the access damper 4, access container 13 is attached to access compartment 15 of casing 2, and the repair drum 29 is attached to access container 13. Remote control with power supply 24 is connected to repair drum 29. Access container 13 is provided with magazine 25. Self-moving installation plug 27 with CCTV camera 20 and electric pump 28 are placed on access tray 19. Exit container 14 is attached to exit compartment 16 (shown in FIG. 1).

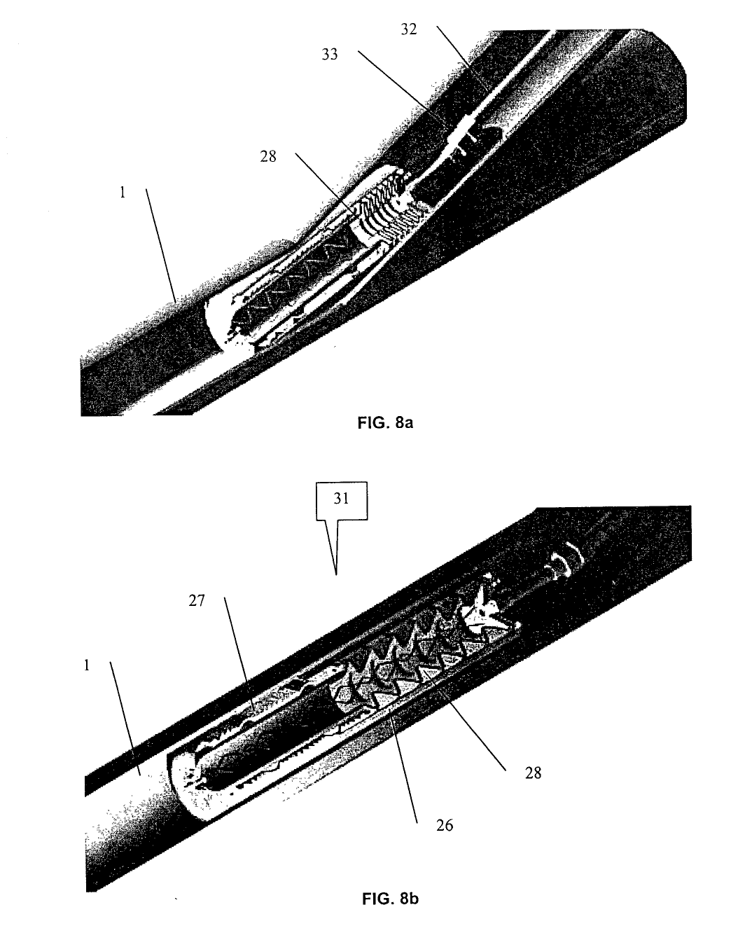

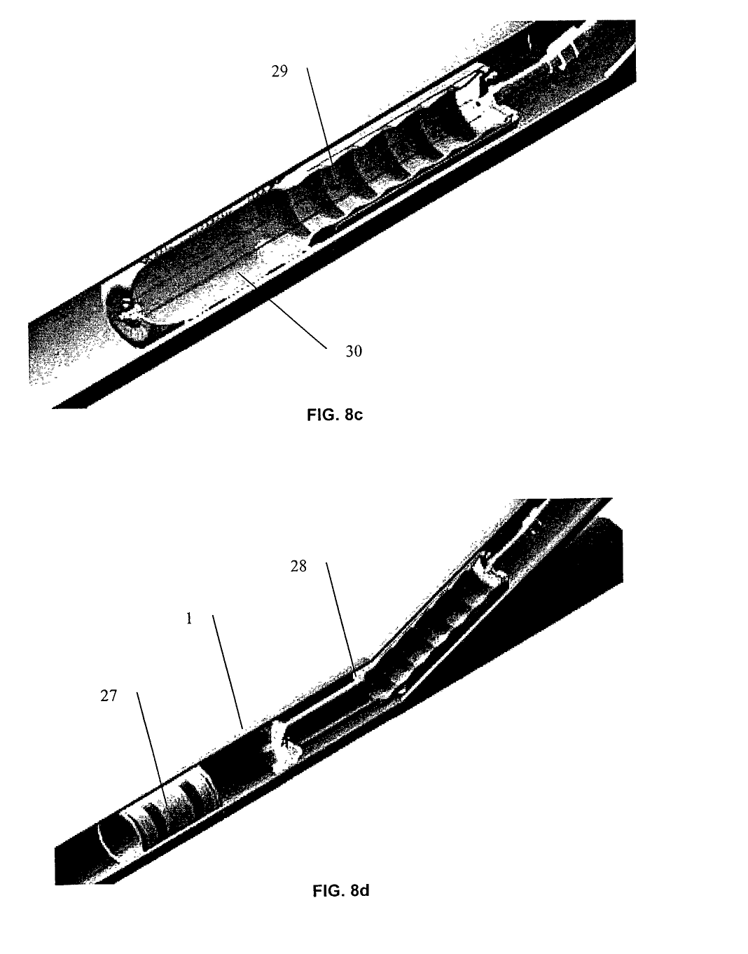

FIGS. 8a-8d illustrate a repair process within the in-service main pipe 1 in accordance with another embodiment of this invention. Hose 32, which supply plug-bellows 28 with pressurized gas, is connected to the plug-bellows by quick connect set 33.

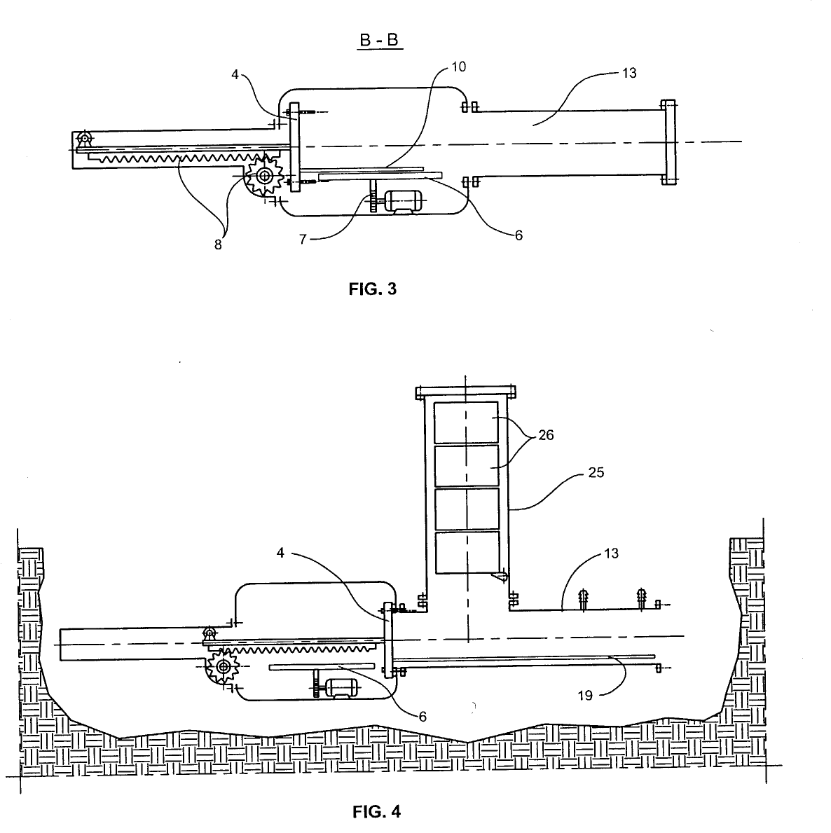

The above-described apparatus operates in the following manner. First, the apparatus for the insertion of treatment devices and materials into an in-service pipeline is hermetically mounted on the main pipe 1, as shown in FIGS. 1-3. Cutter 9 is mounted on cutter platform 10 (see FIG. 5a). The cutting process can be performed with two diamond wires 11 simultaneously. It is apparent that, before cutting, air in the apparatus should be exchanged for inert gas.

After cutting out segment 17 from the main pipe 1, this detached segment 17 is moved into exit compartment 16 by sliding onto side tray 6 (FIG. 5b). At the same time, access damper 4 is moved (with cutter 9 and cutter platform 10) to close the access opening.

After sealing the access damper 4 against access container 13, the gas in the container 13 must be replaced by air. Then, as shown in FIG. 5c, cutter 9 with cutter platform 10 can be removed from access container 13, and detached segment 17 can be moved into exit container 14 with simultaneous closing the exit opening by exit damper 5. Then, the removal of segment 17 from exit container 14 is similar to the removal of cutter 9 from access container 13.

For the main pipe 1 inspection, CCTV crawler camera 20 is placed on access tray 19 (see FIG. 6a), CCTV drum 21 with remote control 24 are attached to access container 13, exit container 14 is sealed by end plate 22, side tray 6 is placed in the middle position, and air in access 13 and exit 14 containers is exchanged for inert gas. Then, CCTV crawler camera 20 is moved into access compartment by opening access damper 4 and is gripped by side tray 6 (see FIG. 6b). Next, camera 20 is aligned by side tray 6 with main pipe 1. Next, CCTV camera 20 is manipulated inside pipe 1 as needed by operating from remote control device 24 (see FIG. 6c). CCTV removal is in inverse order. So, CCTV camera 20 is moved from pipe 1 onto side tray 6 (see FIG. 6d). Then, camera 20 is moved onto access tray 19 by moving side tray 6 (see FIG. 6e). Next, access tray 19 with camera 20 are moved into access container 13, with simultaneous closing access opening by access damper 4. Finally, gas in access container 13 is changed for air.

For the main pipe 1 repair, self-moving installation plug 27 with CCTV camera 20 and electric pump 28 are placed on access tray 19 (see FIG. 7a). Then, box 30 with repair sleeve inside is dropped onto access tray 19, and air in access container 13 is changed for inert gas (see FIG. 7b). Then, plug 27 with CCTV camera 20 and electric pump 28 are moved into box 30 (i.e., repair kit 31). Then, repair kit 31 is transferred by access tray 19 into access compartment 15 by opening access damper 4 (see FIG. 7c) and gripped by side tray 6 (see FIG. 7d). Then, repair kit 31 is aligned by side tray 6 with pipe 1 (see FIG. 7e). Next, repair kit 31 is manipulated inside pipe 1 as needed by operating from remote control device 24, side tray 6 is moved in the middle position, exit damper 5 is moved to open exit container 14 (see FIG. 7f). After repair, repair kit 31 without installed sleeve is pulled back and removed from box 30. Empty box 30 is moved into exit compartment 16 by sliding onto side tray 6 (see FIG. 7g). Then, repair kit 31 is moved onto access tray 19 and is ready to move into access container 13 and take the next box with repair sleeve. In turn, empty box 30 is pushed by exit damper 5 into exit container 14 (see FIG. 7h).

In the case of another embodiment, where repair kit 31 is provided by plug-bellows 28 (see FIGS. 4a, 4b, and 8a-8d), the repair kit 31 is pulled into the main pipe 1 by semi-rigged hose 32 (see FIG. 8a). The plug-bellows 28 is in the deflated mode. Then repair kit 31 has reached the repair position, and repair sleeve 27 is extended from box 26 by inflating plug-bellows 28 (see FIG. 8b). Next, bellows 29 is fully extended (see FIG. 8c), and plug 30 (as part of the plug-bellows 28) starts expansion in the radial direction because of continued growing of installation pressure inside plug-bellows 28. After repair, plug-bellows 28 is deflated (see FIG. 8d) and, without installed sleeve 27, is pulled back and removed from main pipe 1 into the universal access chamber.

Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An apparatus for insertion of treatment devices and materials into an in-service main pipe, said apparatus comprising:
a casing hermetically mounted on the main pipe, said casing having acess and exit compartments;
sealing structures for said access and exit compartments of said casing;
access and exit containers hermetically attached to said compartments; and
arrangements to transfer said treatment devices and materials into and within said main pipe.

2. The apparatus, as claimed in claim 1, wherein said casing is provided with fittings for adjusting said casing to main pipes with different diameters.

3. The apparatus, as claimed in claim 1, wherein said main pipe is provided with a smooth covering for providing said casing to be leak-proof.

4. The apparatus, as claimed in claim 1, wherein said sealing structures for said access and exit compartments are provided with dampers for sealing said casing from inside.

5. The apparatus, as claimed in claim 1, wherein said access container is provided with a magazine for supply of boxes with repair materials.

6. The apparatus, as claimed in claim 1, wherein said containers are provided with additional drums for storage, transfer, and supply said treatment devices, materials, and coiled means into and within said main pipe.

7. The apparatus, as claimed in claim 5, wherein each said box is provided with an inflatable plug and bellows for removing repair materials from said box and installation of said materials inside said main pipe.
